(19) United States
(12) Patent Application Publication
(10) Pub. No.: US 2015/0044894 A1
(43) Pub. Date: Feb. 12, 2015

(54) USB/MINI USB CONVERTIBLE CONNECTOR

(71) Applicant: Ting-Chi Chen, New Taipei City (TW)

(72) Inventors: Ting-Chi CHEN, New Taipei City (TW); Su-Yung CHOU, New Taipei City (TW); Yi-Chieh LIN, New Taipei City (TW); Te-Fu LU, New Taipei City (TW)

(73) Assignee: Ting-Chi Chen, New Taipei City (TW)

(21) Appl. No.: 14/090,942

(22) Filed: Nov. 26, 2013

(30) Foreign Application Priority Data
Aug. 7, 2013 (TW) 102128345

(51) Int. Cl. H01R 29/00

(52) U.S. Cl. CPC H01R 29/00
USPC 439/217

(57) ABSTRACT

A USB/Mini USB convertible connector includes a mating connector including an electrical insulating terminal holder, a conducting terminal set mounted in the electrical insulating terminal holder and an EMI shielding shell surrounding the electrical insulating terminal holder and the conducting terminal set and configured to fit USB3.0 or USB2.0 standard, and an adapter connector including an electrical insulating terminal block detachably insertable into the mating connector, a signal terminal set mounted in the electrical insulating terminal block for conduction with the conducting terminal set of the mating connector and an EMI shielding cover surrounding the electrical insulating terminal block and the signal terminal set and configured to fit Micro USB2.0/Micro USB3.0 or Mini USB2.0/Mini USB3.0 standard. Therefore, the USB/Mini USB convertible connector of the invention saves much installation space and provides a wide range of applications.

This application claims the priority benefit of Taiwan patent application number 102128345, filed on Aug. 7, 2013.

### BACKGROUND OF THE INVENTION

1. Field of the Invention

The present invention relates to electrical connectors, and more particularly to a USB/Mini USB convertible connector, which includes a mating connector configured subject to a first predetermined electrical connector standard for the connection of a first external mating electrical connector, and an adapter connector configured subject to a second predetermined standard and detachably connectable to the mating connector for the connection of a second external mating electrical connector.

2. Description of the Related Art

Following fast development of computer electronic technology, many high mobility electrical and electronic apparatus are well developed and widely used by people for different applications, bringing convenience to people and making people's life more comfortable. Further, high-speed, high-power and sophisticated mobile electrical and electronic devices and related products with large capacity and low profile characteristics have been continuously created. Further, many different transmission interfaces and connectors are widely used in electrical and electronic products for power and data transmission. For connecting different component parts, different transmission interfaces or connectors of different sizes and configurations must be used. Therefore, an electrical or electronic device needs to provide sufficient installation space for the installation of different types of transmission interfaces and connectors.

Further, it is the market trend to create mobility electronic apparatuses having light, thin, short and small characteristics. In consequence, circuit board electronic components must be made extremely strong, small and precise. Further, many different male and female electrical connectors are used in an electronic apparatus to connect different components and parts to a circuit board for the connection of mating electronic cards and/or connectors. These electrical connectors occupy much circuit layout space of the circuit board and the inside space of the electronic apparatus. It is quite important to fully utilize the circuit layout space of a circuit board and the internal space of an electronic apparatus.

### SUMMARY OF THE INVENTION

The present invention has been accomplished under the circumstances in view. It is one object of the present invention to provide a USB/Mini USB convertible connector, which requires less installation space and provides a wide range of applications.

To achieve this and other objects of the present invention, a USB/Mini USB convertible connector of the present invention comprises a mating connector, and an adapter connector detachably connectable to the mating connector. The mating connector comprises an electrical insulating terminal holder, a conducting terminal set mounted in the electrical insulating terminal holder and an EMI shielding shell surrounding the electrical insulating terminal holder and the conducting terminal set and configured to fit a first predetermined electrical connector standard. The adapter connector comprises an electrical insulating terminal block detachably insertable into the mating connector, a signal terminal set mounted in the electrical insulating terminal block for conducting the conducting terminal set, and an EMI shielding cover surrounding the electrical insulating terminal block and the signal terminal set and configured to fit a second predetermined standard. Thus, the mating connector can be used independently for the connection of a first external connector. Alternatively, the mating connector can be used with the adapter connector for the connection of a second external connector. Therefore, the USB/Mini USB convertible connector of the invention saves much installation space and provides a wide range of applications.

Further, the conducting terminal set of the mating connector comprises a plurality of conducting terminals and transmission terminals. The conducting terminals and transmission terminals each comprise a contact portion located at a front end thereof and suspending in the electrical insulating terminal holder, and a bonding portion located at a rear end thereof and extended out of the electrical insulating terminal holder for bonding to an external circuit. The signal terminals of the adapter connector each comprise a mating contact portion located at a front end thereof and suspending in the electrical insulating terminal block, and an abutment portion located at an opposing rear end thereof for abutment against the contact portion of one conducting terminal or transmission terminal of the conducting terminal set of the mating connector.

Further, the bonding portions of the conducting terminal set of the mating connector can be arranged in a coplane manner for bonding to an external circuit board by SMT. Alternatively, the bonding portions of the conducting terminal set of the mating connector can be configured for bonding to an external circuit board in dual in-line package.

Further, the conducting terminal set comprises 5 pcs of conducting terminals and 4 pcs of transmission terminals. The 5 pcs of conducting terminals are configured to fit USB3.0 standard, and defined as a 1^{st} grounding terminal disposed on the middle, a 1^{st} differential signal terminal disposed at one lateral side relative to said 1^{st} grounding terminal, a 2^{nd} differential signal terminal spaced between said 1^{st} grounding terminal and said 1^{st} differential signal terminal, a 3^{rd} differential signal terminal disposed at an opposite lateral side relative to said 1^{st} grounding terminal, and a 4^{th} differential signal terminal disposed at one lateral side relative to said 3^{rd} differential signal terminal opposite to said 1^{st} grounding terminal. The 4 pcs of transmission terminals are configured to fit USB2.0 standard, and defined as a 5^{th} differential signal terminal, a 6^{th} differential signal terminal, a 1^{st} power terminal and a 2^{nd} grounding terminal. The 5^{th} differential signal terminal and the 6^{th} differential signal terminal are arranged on the middle in a parallel manner. The 1^{st} power terminal and the 2^{nd} grounding terminal are respectively disposed at two opposite lateral sides relative to the 5^{th} differential signal terminal and the 6^{th} differential signal terminal.

Further, the signal terminal set comprises 4 pcs of signal terminals configured to fit Micro USB2.0 or Mini USB2.0 standard. These 4 pcs of signal terminals are defined as a 7^{th} differential signal terminal and a 8^{th} differential signal terminal arranged on the middle in a parallel manner, and a 2^{nd} power terminal and a 3^{rd} grounding terminal disposed at two opposite lateral sides relative to the 7^{th} differential signal terminal and the 8^{th} differential signal terminal. The signal terminal set further comprises a supplementary transmission conductor connected to an inner side of the 3^{rd} grounding terminal adjacent to the 7^{th} differential signal terminal, and adapted to match with the 4 pcs of signal terminals in fitting USB/OTG specifications. Further, the mating contact portion of the 2^{nd} power terminal of the signal terminal set has an expanded width for high current load, defining two separated contact surfaces that constitute an open loop configuration.

### BRIEF DESCRIPTION OF THE DRAWINGS

FIG. 1 is an oblique top elevation of a USB Mini USB convertible connector in accordance with the present invention.

FIG. 2 is an exploded view of the USB/Mini USB convertible connector in accordance with the present invention.

FIG. 3 corresponds to FIG. 2 when viewed from another angle.

FIG. 4 is an exploded view of present invention, illustrating the mating connector and the adapter connector respectively assembled before connection.

FIG. 5 is a schematic top view illustrating the arrangement of the conducting terminals and transmission terminals of the conducting terminal set in accordance with the present invention.

FIG. 6 is a schematic top view illustrating the arrangement of the signal terminals of the signal terminal set in accordance with the present invention.

FIG. 7 is a sectional side view of the USB/Mini USB convertible connector in accordance with the present invention.

FIG. 8 is a schematic applied view of the present invention, illustrating an application example of the USB/Mini USB convertible connector in accordance with the present invention.

### DETAILED DESCRIPTION OF THE PREFERRED EMBODIMENT

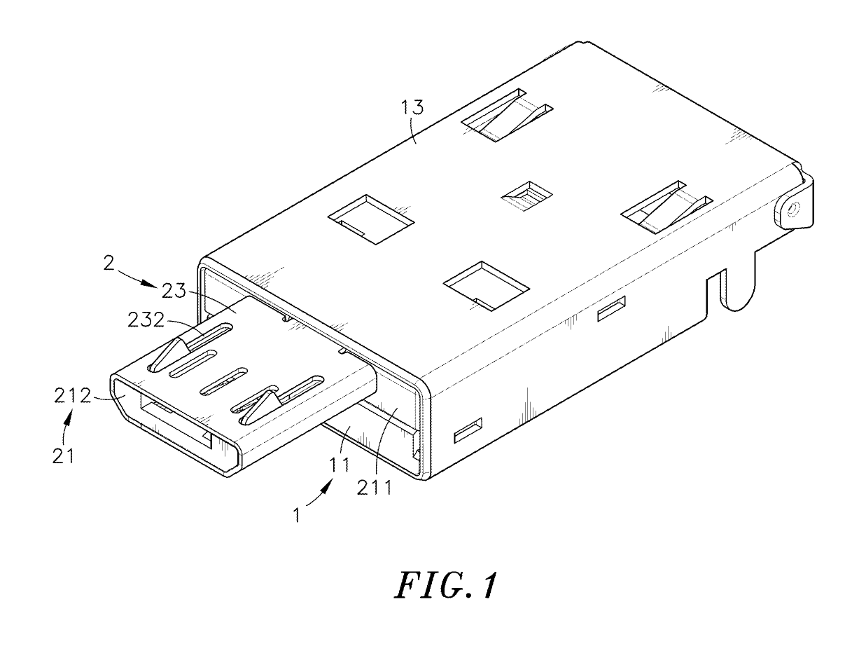

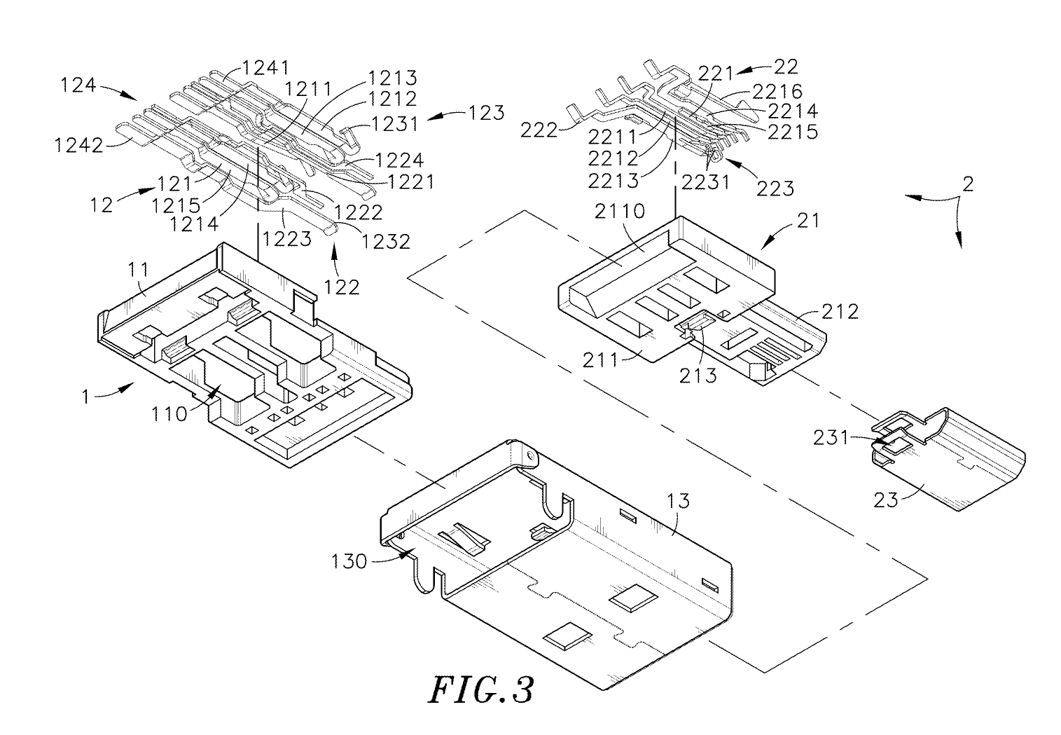

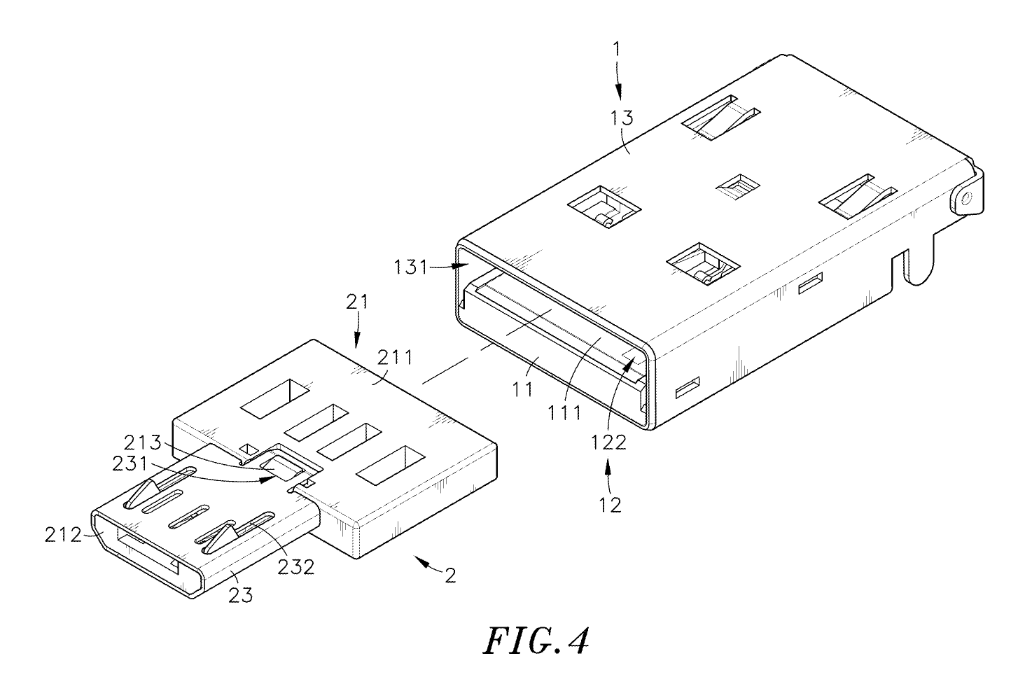

Referring to FIGS. 1-4, a USB/Mini USB convertible connector in accordance with the present invention is shown. As illustrated, the USB/Mini USB convertible connector in accordance with the present invention comprises a mating connector 1 and an adapter connector 2.

The mating connector 1 comprises an electrical insulating terminal holder 11, a conducting terminal set 12 and an EMI shielding shell 13. The electrical insulating terminal holder 11 comprises a plurality of openings 110 cut through opposing top and bottom walls thereof, a mating connection surface 111 at a front side of the openings 110. The conducting terminal set 12 is mounted in the electrical insulating terminal holder 11, comprising a plurality of conducting terminals 121 and a plurality of transmission terminals 122. The conducting terminals 121 and the plurality of transmission terminals 122 each have a contact portion 123 at one end thereof and a bonding portion 124 at an opposite end thereof. The contact portions 123 and bonding portions 124 of the conducting terminals 121 are respectively defined as first contact portions 1231 and first bonding portions 1241. The contact portions 123 and bonding portions 124 of the transmission terminals 122 are respectively defined as second contact portions 1232 and second bonding portions 1242. The first contact portions 1231 of the conducting terminals 121 are respectively suspended in the openings 110 of the electrical insulating terminal holder 11. The second contact portions 1232 of the transmission terminals 122 are extended to the mating connection surface 111 of the electrical insulating terminal holder 11. The first bonding portions 1241 of the conducting terminals 121 and the second bonding portions 1242 of the transmission terminals 122 are respectively extended out of the electrical insulating terminal holder 11 for bonding to an external circuit. The EMI shielding shell 13 comprises a mating chamber 130 extending through opposing front and rear sides thereof for accommodating the electrical insulating terminal holder 11 and the conducting terminal set 12. The EMI shielding shell 13 surrounding the electrical insulating terminal holder 11, defining therein an insertion space 131 that fits a predetermined electrical connector standard (USB3.0 or USB2.0).

The adapter connector 2 comprises an electrical insulating terminal block 21, a signal terminal set 22 and an EMI shielding cover 23. The electrical insulating terminal block 21 comprises a base portion 211, a front tongue portion 212 forwardly extended from the base portion 211, a recessed accommodation chamber 2110 defined in a rear bottom side of the 12 of the base portion 211, two hook blocks 213 respectively located at opposing top and bottom walls between the base portion 211 and the front tongue portion 212, and a plurality of terminal grooves 2120 defined in the front tongue portion 212. The signal terminal set 22 comprises a plurality of signal terminals 221 respectively mounted in the terminal grooves 2120. Each signal terminal 221 comprises an abutment portion 222 located at a rear end thereof and suspending in the recessed accommodation chamber 2110, and a mating contact portion 223 located at an opposing front end thereof and suspending in one respective terminal groove 2120. The EMI shielding cover 23 surrounds the front tongue portion 212 of the electrical insulating terminal block 21, comprising an accommodation chamber 230 extending through opposing front and rear sides thereof for accommodating the front tongue portion 212, two hook holes 231 located at a rear side thereof at different elevations and respectively forced into engagement with the hook blocks 213 of the electrical insulating terminal block 21. The adapter connector 2 can be configured to fit Micro USB2.0, Micro USB3.0, Mini USB2.0 or Mini USB3.0 standard.

After the mating connector 1 and the adapter connector 2 are respectively assembled, the electrical insulating terminal block 21 of the adapter connector 2 can be detachably inserted into the insertion space 131 defined in the EMI shielding shell 13 around the electrical insulating terminal holder 11 to abut the abutment portions 222 of the signal terminals 221 of the signal terminal set 22 against the respective contact portions 123 (first contact portions 1231 or second contact portions 1232) of the conducting terminals 121 or transmission terminals 122 of the conducting terminal set 12. Thus, the mating connector 1 can be used independently, or used with the adapter connector 2.

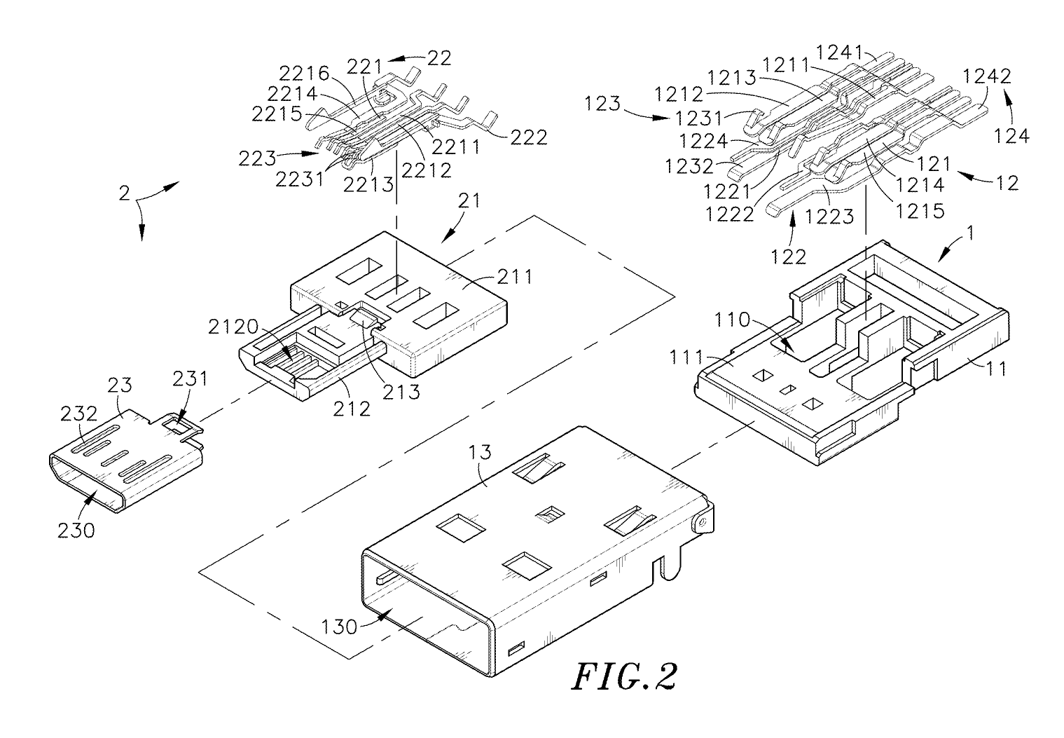

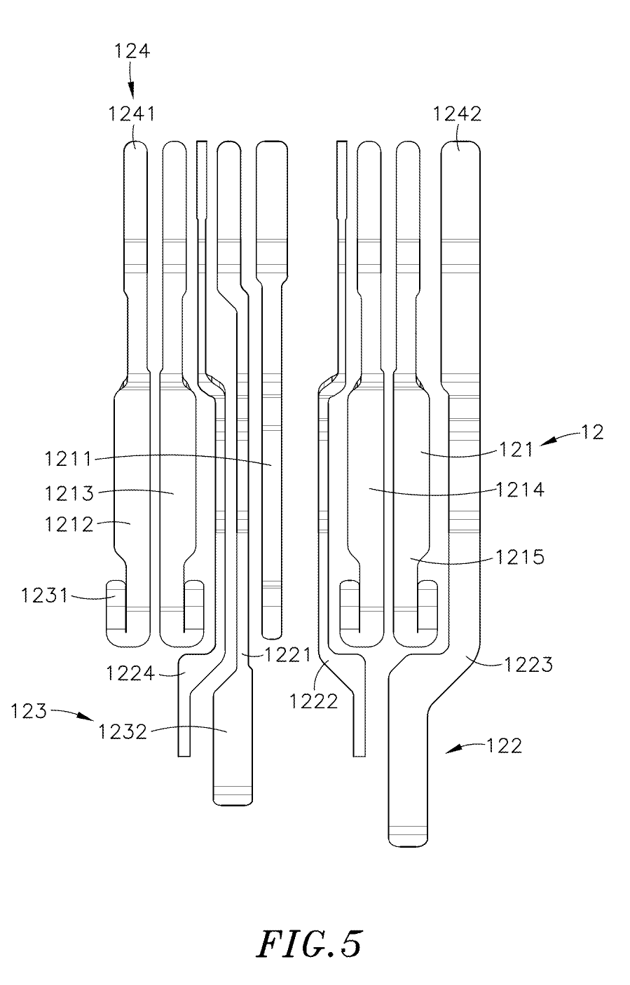

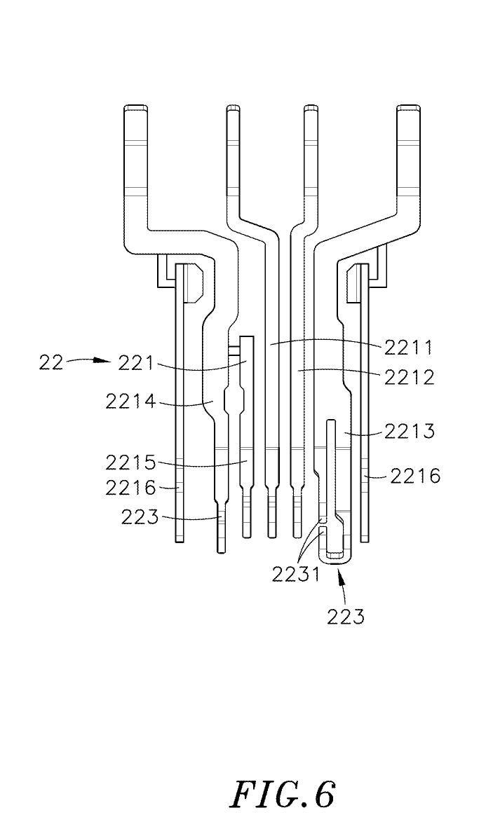

Referring to FIGS. 5 and 6 and FIGS. 2 and 3 again, the conducting terminal set 12 of the mating connector 1 comprises 5 pcs of conducting terminals 121 and 4 pcs of transmission terminals 122. The 5 pcs of conducting terminals 121 are configured to fit USB3.0 standard, and defined as the 1^{st} grounding terminal 1211 disposed on the middle, the 1^{st} differential signal terminal 1212 disposed at one lateral side relative to the 1^{st} grounding terminal 1211, the 2^{nd} differential signal terminal 1213 spaced between the 1^{st} grounding terminal 1211 and the 1^{st} differential signal terminal 1212, the 3^{rd} differential signal terminal 1214 disposed at an opposite lateral side relative to the 1^{st} grounding terminal 1211, and the 4^{th} differential signal terminal 1215 disposed at one lateral side relative to the 3^{rd} differential signal terminal 1214 opposite to the 1^{st} grounding terminal 1211. The 4 pcs of transmission terminals 122 are configured to fit USB2.0 standard, and defined as the 5^{th} differential signal terminal 1221, the 6^{th} differential signal terminal 1222, the 1^{st} power terminal 1223 and the 2^{nd} grounding terminal 1224. The 5^{th} differential signal terminal 1221 and the 6^{th} differential signal terminal 1222 are arranged on the middle in a parallel manner, and the 1^{st} power terminal 1223 and the 2^{nd} grounding terminal 1224 are respectively disposed at two opposite lateral sides relative to the 5^{th} differential signal terminal 1221 and the 6^{th} differential signal terminal 1222. The signal terminal set 22 of the adapter connector 2 comprises 4 pcs of signal terminals 221 configured to fit Micro USB2.0 standard and defined as the 7^{th} differential signal terminal 2211 and the 8^{th} differential signal terminal 2212 arranged on the middle in a parallel manner and the 2^{nd} power terminal 2213 and the 3^{rd} grounding terminal 2214 disposed at two opposite lateral sides relative to the 7^{th} differential signal terminal 2211 and the 8^{th} differential signal terminal 2212. The signal terminal set 22 further comprises a supplementary transmission conductor 2215 connected to an inner side of the 3^{rd} grounding terminal 2214 adjacent to the 7^{th} differential signal terminal 2211 and adapted to match with the 4 pcs of signal terminals 221 in fitting USB/OTG specifications. Further, the mating contact portion 223 of the 2^{nd} power terminal 2213 of the signal terminal set 22 has an expanded width for high current load. The mating contact portion 223 of the 2^{nd} power terminal 2213 defines two separated contact surfaces 2231 that constitute an open loop configuration. Further, the 2^{nd} power terminal 2213 and the 3^{rd} grounding terminal 2214 of the signal terminal set 22 each comprise a resilient hook rod 2216 respectively forwardly extended from an outer side thereof and respectively inserted through a respective insertion slot 232 in the top wall of the EMI shielding cover 23. Thus, the adapter module 2 can be selectively configured to fit Micro USB2.0 or Mini USB2.0 standard.

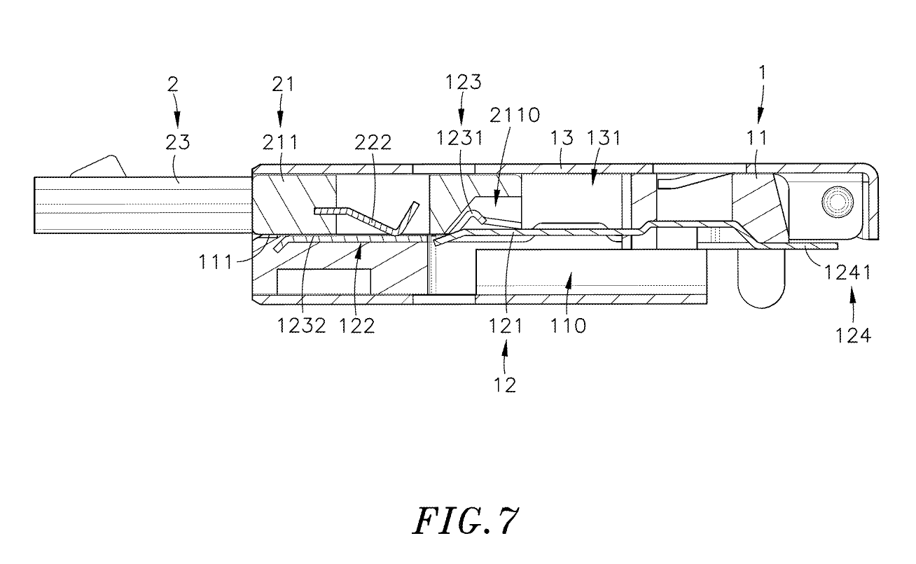

Referring to FIG. 7 and FIGS. 2-4 again, the insertion space 131 defined in the EMI shielding shell 13 around the electrical insulating terminal holder 11 and the contact portions 123 of the conducting terminals 121 of the conducting terminal set 12 of the mating connector 1 is adapted for receiving a predetermined electrical connector (that fits USB3.0 or USB2.0 standard) for signal transmission through the conducting terminal set 12.

Further, the electrical insulating terminal block 21 of the adapter connector 2 can be detachably inserted into the insertion space 131 defined in the EMI shielding shell 13 around the electrical insulating terminal holder 11 of the mating connector 1 to abut the abutment portions 222 of the signal terminals 221 of the signal terminal set 22 against the respective contact portions 123 (first contact portions 1231 or second contact portions 1232) of the conducting terminals 121 or transmission terminals 122 of the conducting terminal set 12. Thus, the mating connector 1 can be used with the adapter connector 2 for the connection of a mating (Micro USB2.0/Micro USB3.0 or Mini USB2.0/Mini USB3.0) connector for signal transmission through the conducting terminal set 12 and the signal terminal set 22. Thus, the USB/Mini USB convertible connector of the invention can be configured and selectively used for different applications.

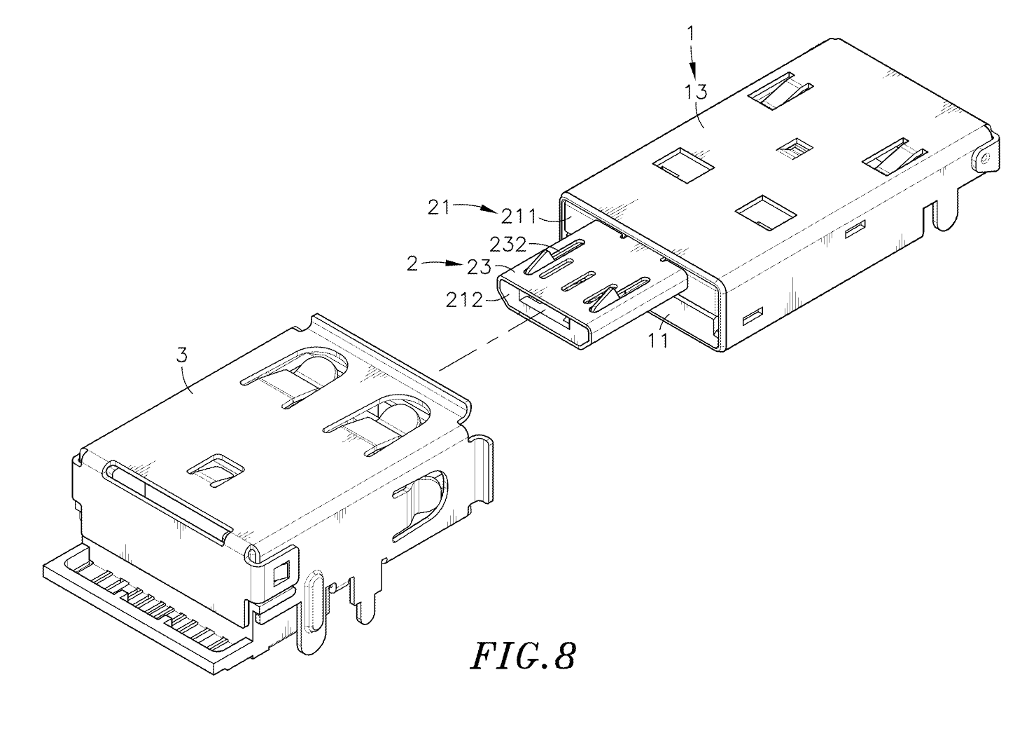

Referring to FIG. 8 and FIGS. 2, 3 and 4 again, the mating connector 1 can be separately used for the connection of a predetermined external electrical connector. Alternatively, the adapter connector 2 can be inserted into the insertion space 131 defined in the EMI shielding shell 13 around the electrical insulating terminal holder 11 of the mating connector 1 for the connection of another predetermined external electrical connector. Thus, the USB/Mini USB convertible connector of the invention has a wide range of applications.

In conclusion, the invention provides a USB/Mini USB convertible connector, which comprises a mating connector, which comprises an electrical insulating terminal holder, a conducting terminal set mounted in the electrical insulating terminal holder and an EMI shielding shell surrounding the electrical insulating terminal holder and the conducting terminal set and, is configured to fit USB3.0 or USB2.0 standard, and an adapter connector, which comprises an electrical insulating terminal block detachably insertable into the mating connector, a signal terminal set mounted in the electrical insulating terminal block for abutment against conducting terminals (or transmission terminals) of the conducting terminal set and an EMI shielding cover surrounding the electrical insulating terminal block and the signal terminal set and, is configured to fit Micro USB2.0/Micro USB3.0 or Mini USB2.0/Mini USB3.0 standard. Therefore, the USB/Mini USB convertible connector of the invention saves much installation space and provides a wide range of applications.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A USB/Mini USB convertible connector, comprising:
a mating connector comprising an electrical insulating terminal holder, a conducting terminal set mounted in said electrical insulating terminal holder, said conducting terminal set comprising a plurality of conducting terminals and a plurality of transmission terminals, said conducting terminals and said transmission terminals each comprising a contact portion located at a front end thereof and suspending in said electrical insulating terminal holder and a bonding portion located at an opposing rear end thereof and extended out of a rear side of said electrical insulating terminal holder for bonding to an external circuit, and an EMI shielding shell surrounding said electrical insulating terminal holder and said conducting terminal set and defining therein an insertion space configured to fit a first predetermined USB (universal serial bus) standard; and
an adapter connector detachably connectable to said mating connector for the connection of a predetermined external electrical connector, said adapter connector comprising an electrical insulating terminal block detachably insertable into said insertion space in said EMI shielding shell of said mating connector, a signal terminal set mounted in said electrical insulating terminal block, said signal terminal set comprising a plurality of signal terminals, each said signal terminal comprising a mating contact portion located at a front end thereof and suspending in said electrical insulating terminal block and an abutment portion located at a rear end thereof for abutment against the contact portion of one of said conducting terminals and said transmission terminals of said conducting terminal set, and an EMI shielding cover surrounding said electrical insulating terminal block and said signal terminal set and configured to fit a second predetermined USB (universal serial bus) standard.

2. The USB/Mini USB convertible connector as claimed in claim 1, wherein said mating connector is selectively configured subject to fit one of USB3.0 and USB2.0 standards; said adapter connector is selectively configured to fit one of Micro USB3.0, Micro USB2.0, Mini USB3.0 and Mini USB2.0 standards.

3. The USB/Mini USB convertible connector as claimed in claim 1, wherein said electrical insulating terminal holder comprises a plurality of openings cut through opposing top and bottom walls thereof, and a mating connection surface located at a front side of relative to said openings; the contact portions and bonding portions of said conducting terminals are respectively defined as first contact portions and first bonding portions, said first contact portions being respectively suspended in said openings of said electrical insulating terminal holder, said first bonding portions being extended out of the rear side of said electrical insulating terminal holder; the contact portions and bonding portions of said transmission terminals are respectively defined as second contact portions and second bonding portions, said second contact portions being extended to said mating connection surface of said electrical insulating terminal holder, said second bonding portions being extended out of the rear side of said electrical insulating terminal holder.

4. A USB/Mini USB convertible connector, comprising:
a mating connector comprising an electrical insulating terminal holder, said electrical insulating terminal holder comprising a plurality of openings cut through opposing top and bottom walls thereof and a mating connection surface located at a front side of relative to said openings, a conducting terminal set mounted in said electrical insulating terminal holder, said conducting terminal set comprising a plurality of conducting terminals and transmission terminals, said conducting terminals and said transmission terminals each comprising a contact portion located at a front end thereof and a bonding portion located at a rear side thereof, the contact portions of said terminals of said conducting terminal set being selectively suspended in said openings and said mating connection surface of said electrical insulating terminal holder, the bonding portions of said terminals of said conducting terminal set being extended out of a rear side of said electrical insulating terminal holder for bonding to an external circuit, and an EMI shielding shell surrounding said electrical insulating terminal holder and said conducting terminal set and defining therein an insertion space configured to fit a first predetermined USB (universal serial bus) standard; and
an adapter connector detachably connectable to said mating connector for the connection of a predetermined external electrical connector, said adapter connector comprising an electrical insulating terminal block detachably insertable into said insertion space in said EMI shielding shell of said mating connector, a signal terminal set mounted in said electrical insulating terminal block, said signal terminal set comprising a plurality of signal terminals, each said signal terminal comprising a mating contact portion located at a front end thereof and suspending in said electrical insulating terminal block and an abutment portion located at a rear end thereof for abutment against one contact portion of said conducting terminal set, and an EMI shielding cover surrounding said electrical insulating terminal block and said signal terminal set and configured to fit a second predetermined USB (universal serial bus) standard.

5. The USB/Mini USB convertible connector as claimed in claim 4, wherein said conducting terminal set comprises 5 pcs of said conducting terminals and 4 pcs of said transmission terminals, the contact portions of said conducting terminal being defined as first contact portions and respectively suspended in said openings of said electrical insulating terminal holder, the contact portions of said transmission terminals being defined as second contact portions and respectively extended to said mating connection surfaces of said electrical insulating terminal holder.

6. The USB/Mini USB convertible connector as claimed in claim 5, wherein said 5 pcs of conducting terminals are configured to fit USB3.0 standard, and defined as a 1^{st} grounding terminal disposed on the middle, a 1^{st} differential signal terminal disposed at one lateral side relative to said 1^{st} grounding terminal, a 2^{nd} differential signal terminal spaced between said 1^{st} grounding terminal and said 1^{st} differential signal terminal, a 3^{rd} differential signal terminal disposed at an opposite lateral side relative to said 1^{st} grounding terminal, and a 4^{th} differential signal terminal disposed at one lateral side relative to said 3^{rd} differential signal terminal opposite to said 1^{st} grounding terminal.

7. The USB/Mini USB convertible connector as claimed in claim 5, wherein said 4 pcs of transmission terminals are configured to fit USB2.0 standard, and defined as a 5^{th} differential signal terminal, a 6^{th} differential signal terminal, a 1^{st} power terminal and a 2^{nd} grounding terminal, said 5^{th} differential signal terminal and said 6^{th} differential signal terminal being arranged on the middle in a parallel manner, said 1^{st} power terminal and said 2^{nd} grounding terminal being respectively disposed at two opposite lateral sides relative to said 5^{th} differential signal terminal and said 6^{th} differential signal terminal.

8. The USB/Mini USB convertible connector as claimed in claim 4, wherein said mating connector is selectively configured subject to fit one of USB3.0 and USB2.0 standards; said adapter connector is selectively configured to fit one of Micro USB3.0, Micro USB2.0, Mini USB3.0 and Mini USB2.0 standards.

9. The USB/Mini USB convertible connector as claimed in claim 4, wherein said electrical insulating terminal block of said adapter connector comprises a base portion and a front tongue portion forwardly extended from said base portion; said signal terminals of said signal terminal set are mounted in said base portion to suspend said mating contact portions in said front tongue portion; said EMI shielding cover of said adapter connector surrounds said front tongue portion of said electrical insulating terminal block, comprising an accommodation chamber extending through opposing front and rear sides thereof that accommodates said front tongue portion.

10. The USB/Mini USB convertible connector as claimed in claim 4, wherein said electrical insulating terminal block of said adapter connector comprises a base portion, a front tongue portion forwardly extended from said base portion and a plurality of terminal grooves located in said front tongue portion; said signal terminals of said signal terminal set are mounted in said base portion to suspend said mating contact portions in said terminal grooves of said front tongue portion and to abut said abutment portions against respective contact portions of said conducting terminal set.

11. The USB/Mini USB convertible connector as claimed in claim 10, wherein the number of said signal terminals of said signal terminal set is 4, and the 4 pcs of signal terminals configured to fit one of Micro USB2.0 and Mini USB2.0 standards, the 4 pcs of signal terminals being defined as a 7¹¹¹ differential signal terminal and a 8 differential signal terminal arranged on the middle in a parallel manner and a 2^{nd} power terminal and a 3^{rd} grounding terminal disposed at two opposite lateral sides relative to said 7^{th} differential signal terminal and said 8^{th} differential signal terminal.

12. The USB/Mini USB convertible connector as claimed in claim 11, wherein said signal terminal set further comprises a supplementary transmission conductor connected to an inner side of said 3^{rd} grounding terminal adjacent to said 7^{th} differential signal terminal and adapted to match with said 4 pcs of signal terminals in fitting USB/OTG specifications.

13. The USB/Mini USB convertible connector as claimed in claim 11, wherein the mating contact portion of said 2^{nd} power terminal of said signal terminal set has an expanded width for high current load and defines two separated contact surfaces that constitute an open loop configuration.

14. A USB/Mini USB convertible connector, comprising a detachable adapter connector, said adapter connector comprising an electrical insulating terminal block configured subject to a first predetermined USB standard, a signal terminal set mounted in said electrical insulating terminal block, said signal terminal set comprising a plurality of signal terminals, each said signal terminal comprising a mating contact portion located at a front end thereof and suspending in said electrical insulating terminal block and an abutment portion located at an opposing rear end thereof and extended out of said electrical insulating terminal block, and an EMI shielding cover surrounding said electrical insulating terminal block and said signal terminal set and configured to fit a second predetermined USB (universal serial bus) standard.

15. The USB/Mini USB convertible connector as claimed in claim 14, wherein said electrical insulating terminal block configured subject to one of USB3.0 and USB2.0 standard; said EMI shielding cover is configured to fit one of Micro USB3.0, Micro USB2.0, Mini USB3.0 and Mini USB2.0 standards.
